(19) United States
(12) Patent Application Publication
(10) Pub. No.: US 2015/0346316 A1
(43) Pub. Date: Dec. 3, 2015

(54) METHOD AND SYSTEM FOR DETECTING AND LOCATING TRAPPED PEOPLE

(71) Applicant: National Taiwan University of Science and Technology, Taipei (TW)

(72) Inventors: Ray-Guang Cheng, Taipei (TW); Wei-Ru Huang, Taipei (TW); Shin-Ming Cheng, Taipei (TW); Tse-Han Liu, Taipei (TW)

(21) Appl. No.: 14/541,147

(22) Filed: Nov. 14, 2014

(30) Foreign Application Priority Data
May 29, 2014 (TW) 103118780

(51) Int. Cl. G01S 5/02; H04W 4/22

(52) U.S. Cl. CPC G01S 5/0284; H04W 4/22

(57) ABSTRACT

A method and system for detecting and locating trapped people are provided. The method includes the following steps: (a) transmitting a first wireless signal based on a transmission power, and recording the transmission power; (b) when a first mobile device registers to the system for detecting and locating trapped people in response to the first wireless signal, recording identity information of the first mobile device; (c) determining whether the transmission power is a maximum transmission power; (d) if no, increasing the transmission power, and repeating the steps (a) to (d); if yes, calculating a relative location between the first mobile device and the system for detecting and locating trapped people based on the recorded transmission power and the recorded identity information.

### CROSS-REFERENCE TO RELATED APPLICATION

This application claims the priority benefit of Taiwan application serial no. 103118780, filed on May 29, 2014. The entirety of the above-mentioned patent application is hereby incorporated by reference herein and made a part of this specification.

### BACKGROUND

1. Field of the Invention

The invention relates to a locating method and system, particularly method and system for detecting and locating trapped people.

2. Description of Related Art

FIG. 1 illustrates a schematic diagram where base stations lose the ability to communicate with mobile devices after occurrence of disasters. As illustrated in FIG. 1, since rescuers are not able to use damaged base stations (for example, a base station 110) to quickly locate victims' mobile devices (for example, a mobile device 120) for rescue attempt, serious harm to persons and property often results.

One of the conventional locating methods is that a base station transmits wireless signal to communicate with mobile devices, and the base station may use a time difference or a delay time of the wireless signal being transmitted from the mobile device to the base station to calculate the location of the mobile device. However, this method requires the base station and the mobile device to be able to communicate with each other. Moreover, if the mobile device continuously communicates with the base station, the power of the mobile device would rapidly decrease.

A second locating method is to use the serial number of base stations, that is, as long as the base station managing the mobile device is known, the area where the mobile device is could be derived. However, the accuracy of this kind of locating method is quite low.

A third method is to dispose a Global Positioning System (GPS) device to mobile devices. When a base station request to perform positioning, the GPS device may provide the mobile device's satellite positioning message to assist the base station to locate the mobile device. However, when mobile device is being blocked by an object, the base station is unable to use the satellite positioning message to detect the location of the mobile device.

Also, when the base station loses the communicating ability, since mobile devices may continue to try to detect signals from other base stations that can be used for connection, the power consumption of the mobile device may significantly increase. When the mobile device runs out of power, it becomes more difficult for rescuers to locate the user, and hence rescue attempts would become more difficult.

### SUMMARY

Accordingly, the invention proposes a method and system for detecting and locating trapped people, which effectively decreases power consumption and achieves high-accuracy locating performance at the same time.

This invention proposes a method for detecting and locating trapped people, adapted for a system for detecting and locating trapped people. The method includes: (a) transmitting a first wireless signal based on a transmission power, and recording the transmission power; (b) when a first mobile device registers to the system for detecting and locating trapped people in response to the first wireless signal, recording identity information of the first mobile device; (c) determining whether the transmission power is a maximum transmission power; (d) if no, increasing the transmission power, and repeating steps (a) to (d); (e) if yes, calculating a relative location between the first mobile device and the system for detecting and locating trapped people based on the recorded transmission power and the recorded identity information.

In one embodiment, before the step of transmitting the wireless signal based on the transmission power, the method further includes: transmitting a second wireless signal based on the maximum transmission power, and moving in an area; and when a second mobile device registers to the system for detecting and locating trapped people in response to the second wireless signal, recording and stopping at a first location where the system for detecting and locating trapped people currently is.

In one embodiment, before the step of determining whether the transmission power is the maximum transmission power, the method further includes: determining whether the transmission power has lasted one unit of time; if yes, proceeding to step (c); and if no, returning to step (a).

In one embodiment, after the step of calculating the relative location between the first mobile device and the system for detecting and locating trapped people based on the recorded transmission power and the recorded identity information, the method further includes: moving to a second location, and repeating steps (a) to (e).

In one embodiment, when the system for detecting and locating trapped people is registered by a third device in at least three locations, the method further includes: calculating an absolute location of the third mobile device based on a triangulation locating method.

This invention proposes a system for detecting and locating trapped people, which includes a communication unit, a storage unit, and a processing unit. The storage unit stores a plurality of modules. The processing unit is connected to the storage unit and the communications unit. The processing unit accesses the modules for executing the following steps: (a) transmitting a first wireless signal based on a transmission power, and recording the transmission power to the storage unit; (b) when a first mobile device registers to the system for detecting and locating trapped people in response to the first wireless signal, recording identity information of the first mobile device to the storage unit; (c) determining whether the transmission power is a maximum transmission power; (d) if no, increasing the transmission power, and repeating steps (a) to (d); (e) if yes, calculating a relative location between the first mobile device and the system for detecting and locating trapped people based on the recorded transmission power and identity information.

In one embodiment, the processor unit is further configured to: control the communications unit to transmit a second wireless signal based on the maximum transmission power and move in an area; and when a second mobile device registers to the system for detecting and locating trapped people in response to the second wireless signal, record a first location where the system for detecting and locating trapped people currently is to the storage unit and control the system for detecting and locating trapped people to stop at the first location.

In one embodiment, the processing unit is further configured to: determine whether the transmission power has lasted one unit of time; if yes, proceed to step (c); and if no, return to step (a).

In one embodiment, the processing unit is further configured to control the system for detecting and locating trapped people to move to a second location and repeat steps (a) to (e).

In one embodiment, when the system for detecting and locating trapped people is registered by a third mobile device in at least three locations, the processing unit is further configured to calculate an absolute location of the third mobile device based on a triangulation locating method.

As described above, the locating method and the system for detecting and locating trapped people of the embodiment dynamically adjusts transmission power, records the mobile devices registering to the system for detecting and locating trapped people in response to each transmission power at the same time, and accordingly calculates the relative locations between the systems and the mobile devices.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a schematic diagram where base stations lose the ability to communicate with mobile devices after occurrence of disasters.

FIG. 2 illustrates the system for detecting and locating trapped people according to one embodiment of the invention.

FIG. 3 is a flow chart of the locating method according to one embodiment of the invention.

FIG. 4 illustrates the locating mechanism according to the embodiment of FIG. 3.

FIG. 5 is a flow chart of the locating method according to the embodiment of FIG. 3.

FIG. 6 illustrates a schematic diagram of searching for a mobile device with the maximum transmission power according to the embodiment of FIG. 5.

FIG. 7 illustrates a triangulation locating mechanism according to one embodiment of the invention.

FIG. 8 illustrates a triangulation locating mechanism according to one embodiment of the invention.

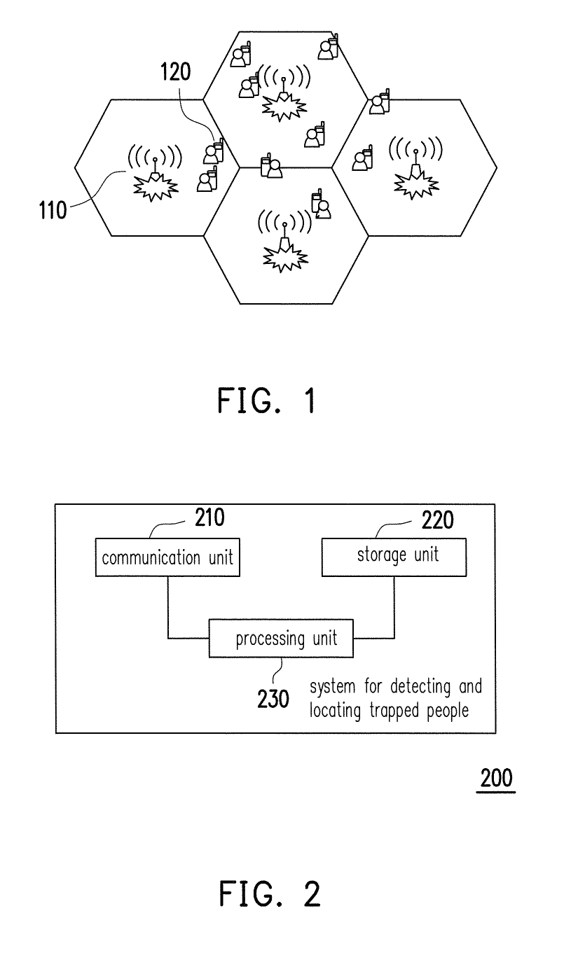

### DETAILED DESCRIPTION OF DISCLOSED EMBODIMENTS

FIG. 2 illustrates a system for detecting and locating trapped people according to one embodiment of the invention. In this embodiment, a system for detecting and locating trapped people 200 includes a mobile enhanced node B (eNodeB), Advanced Base Station (ABS), macro-cell base station, pico-cell base station, or Remote Radio Head (RRH).

The system for detecting and locating trapped people 200 includes a communication unit 210, a storage unit 220, and a processing unit 230. The communication unit 210 may be configured to process radio frequency (RF) of cell communication technology, such as Global System for Mobile (GSM), 3GPP LTE, Code Division Multiple Access (CDMA), wideband CDMA (WCDMA), High Speed Packet Access (HSPA), and World Interoperability for Microwave Access (WiMAX), etc. The storage unit 220 is, for example, a memory, a hard drive, or other component used to store data and record codes or modules.

The processing unit 230 is connected with the communication unit 210 and the storage unit 220. The processing unit 230 includes general purpose processor, special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), an ARM-based processor, and the like.

In this embodiment, the processing unit 230 accesses each module recorded by the storage unit 220 and execute the locating method of this invention.

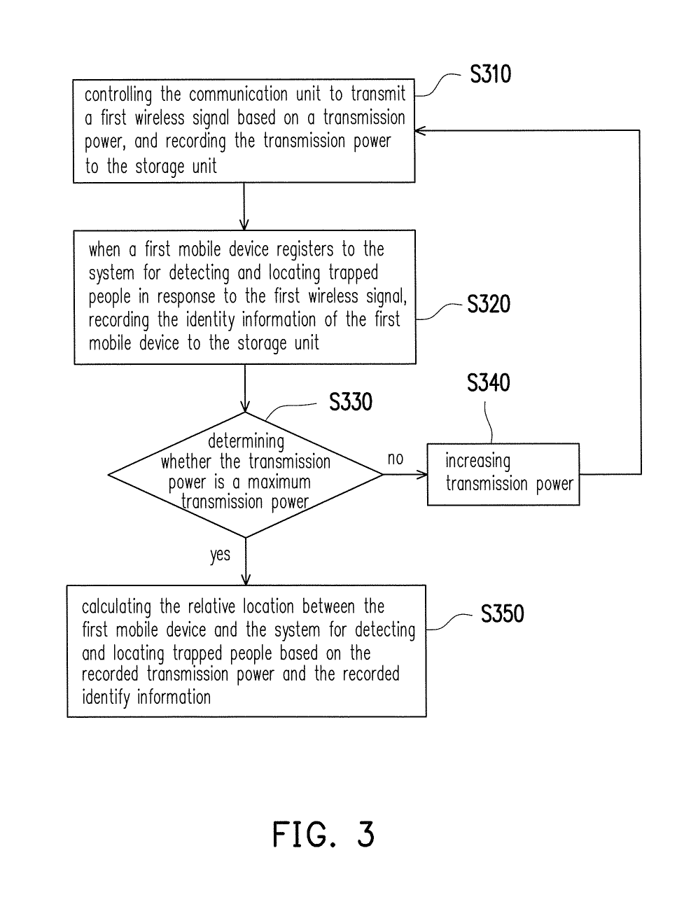

FIG. 3 illustrates a system for detecting and locating trapped people according to one embodiment of the invention. This method proposed in the present embodiment may be executed by the system for detecting and locating trapped people 200 in FIG. 2. This embodiment would be described in detail with the components in FIG. 2 as follows.

In step S310, the processing unit 230 may control the communication unit 210 to transmit a first wireless signal based on a transmission power, and record the transmission power to the storage unit 220. The transmission power is, for example, an initial transmission power, which could be set by the designer. The first wireless signal is, for example, any kind of signals that makes mobile devices haven't registered to a base station accordingly register to the system for detecting and locating trapped people 200 The mobile devices are, for example, mobile stations, Advanced Mobile Stations (AMS), or wireless terminal communication devices. In addition, the mobile devices may also be mobile phones, smart phones, tablet PCs, and other similar devices.

In one embodiment, each of the mobile devices may include, for example, a transceiver (not shown), a communication protocol module (not shown), and a memory (not shown). The transceiver and memory may be connected to the communication protocol module. The transceiver may be configured to transmit signals to and receive signals from other device within its transmission range. The transceiver executes analog-to-digital conversion (ADC), digital-to-analog conversion (DAC), modulation, demodulation, signal amplification, low-pass filtering, and bandpass filtering. For instance, the transceiver is configured to provide a communication protocol module with the information of received signals, modulate the data received from the communication protocol as a modulated signal, and transmits the modulated signal to other devices.

The communication protocol module may be configured to receive request messages from other devices and processes the commands within the messages (or execute corresponding operations based on the parameters in the messages). The communication protocol module may include a processor and embedded software or firmware. Embedded software or firmware may include source code of communications protocol stacks. Additionally, memory may be configured to temporarily store various data and other data. The mobile devices may further include other components (such as an antenna module) to implement the aforementioned functions of the transceiver, the communication protocol module and the memory. According to the adopted wireless network mechanism (e.g., CDMA, WCDMA, GSM, UMTS, 3G, 4G, WiMAX, LTE, etc.), other elements can be included for the system for detecting and locating trapped people 200 and the mobile devices.

The mobile devices described in the following descriptions have similar or identical characteristics to those described above.

Next, as illustrated in step S320, when a first mobile device registers to the system for detecting and locating trapped people 200 in response to the first wireless signal, the processing unit 230 may record the identity information of the first mobile device to the storage unit 220. The identity information includes International Mobile Subscriber Identity (IMSI) of the Subscriber Identification Module (SIM) card of the mobile device, or other information could uniquely identify the first mobile device or its user.

In one embodiment, when the originally registered base station of the first mobile device stops to function due to disaster (such as an earthquake), the first mobile device continues to search for other base stations for connection. After the first mobile device registers to the system for detecting and locating trapped people 200, the first mobile device stops searching and enter a hibernation mode to save power. As a result, rescuers have more time to locate the user of the first mobile device, and hence the difficulty of rescue operations could greatly decrease.

In step S330, the processing unit 230 may determine whether the transmission power is a maximum power. If no, the processing unit 230 proceeds to step S340; if yes, the processing unit 230 proceeds to step S350. The maximum transmission power is, for example, the maximum value of the transmission power could be achieved by the system for detecting and locating trapped people 200.

In step S340, the processing unit 230 may increase the transmission power and repeat steps S310-S330.

After transmission power is increased to the maximum transmission power, in step S350, the processing unit 230 may calculate the relative location between the first mobile device and the system for detecting and locating trapped people 200 based on the recorded transmission power and the recorded identify information.

Specifically, people with ordinary skill in the art should understand that one transmission power substantially corresponds to a transmission range (or a transmission radius). With the repetition of steps S310-S340, the transmission power of the system for detecting and locating trapped people 200 would be gradually increased and thereby the transmission range would be correspondingly increased. Further, the system for detecting and locating trapped people 200 may record the first mobile device registered to the system for detecting and locating trapped people 200 in each transmission range. Thus, the system for detecting and locating trapped people 200 may accurately learn the distances between the system for detecting and locating trapped people 200 and each of the first mobile devices, and further calculate the relative location between each of the first mobile devices and the system for detecting and locating trapped people 200.

From another perspective, the method of this invention uses transmission power to calculate the distance between the system for detecting and locating trapped people 200 and the mobile device, which is different from the traditional method of calculating a time difference or a delay time of the wireless signal being transmitted from the mobile device to the base station to calculate the location of the mobile device. Furthermore, since the method proposed in this invention saves the frequent message exchange between mobile device and the system for detecting and locating trapped people 200, the power consumption of the mobile device may be decreased.

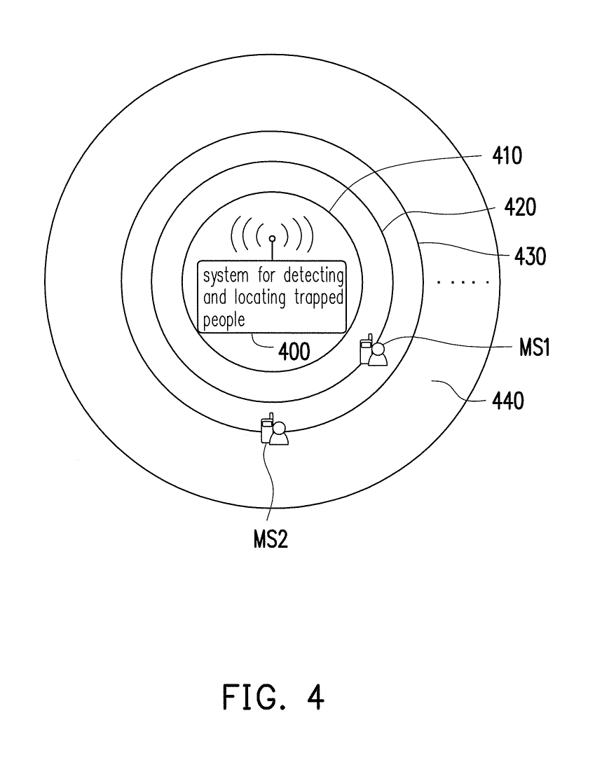

FIG. 4 illustrates the locating mechanism according to the embodiment of FIG. 3. In this embodiment, a transmission range 410 corresponds, for example, to the transmission range of the initial transmission power, and a transmission range 440 corresponds, for example, to the transmission range of the maximum transmission power.

As illustrated in FIG. 4, as no mobile device registered to the system for detecting and locating trapped people 400 within the transmission range 410, the system for detecting and locating trapped people 400 increases the transmission power to increase the transmission range to the transmission range 420. At this time, since a mobile device MS1 is in the transmission range 420, the mobile device MS1 may register to the system for detecting and locating trapped people 400, and then enter the hibernation mode. The system for detecting and locating trapped people 400 records the transmission power (represented by P1) and the identify information (e.g., IMSI) of the mobile device MS1. Next, the system for detecting and locating trapped people 400 may increase the transmission power to extend the transmission range to a transmission range 430. At this time, since a mobile device MS2 is in the transmission range 430, the mobile device MS2 may register to the system for detecting and locating trapped people 400, and then enter the hibernation mode. The system for detecting and locating trapped people 400 may record the transmission power (represented by P2) and the identify information (e.g., IMSI) of the mobile device MS2.

After the system for detecting and locating trapped people 400 extends the transmission range to a transmission range 440, the system for detecting and locating trapped people 400 may respectively calculate the relative locations (e.g., the distance) of the mobile devices MS1 and MS2 based on P1 and P2.

To further increase accuracy of locating, this invention proposes the method in FIG. 4 to further explain the essence of this invention.

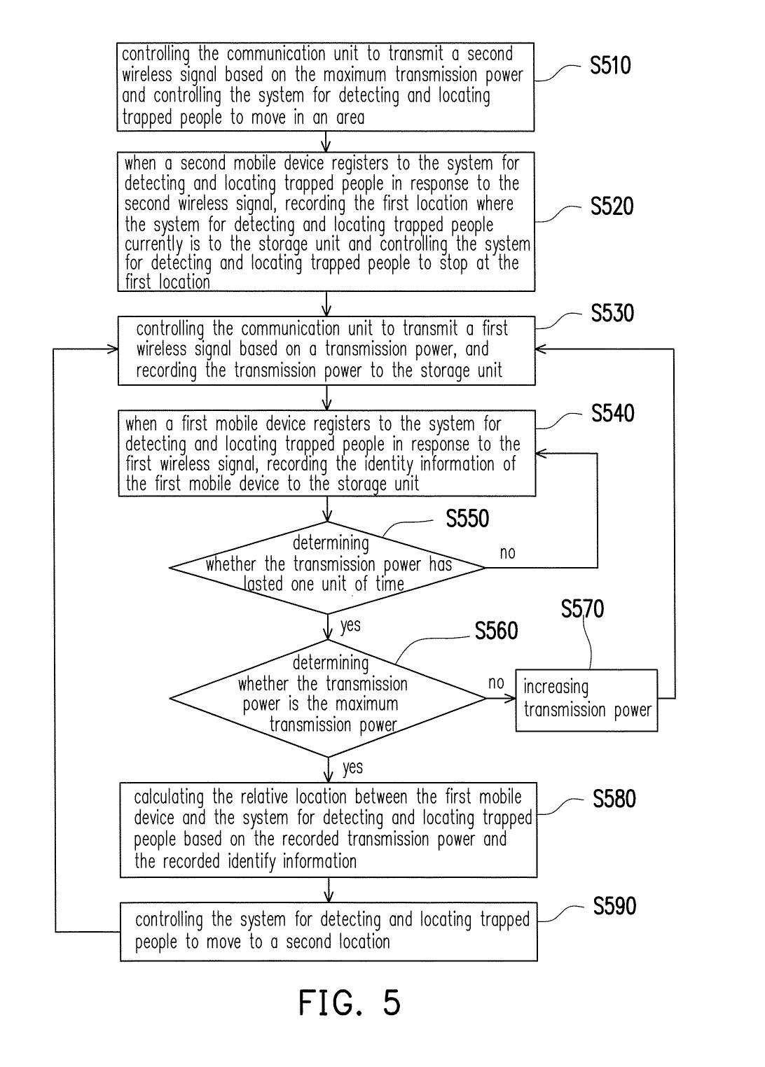

FIG. 5 is a flow chart of the locating method according to the embodiment of FIG. 3. This method proposed in the present embodiment may be executed by the system for detecting and locating trapped people 200 in FIG. 2 as well. This embodiment would be described in detail with the components in FIG. 2 as follows.

In step S510, the processing unit 230 may control the communication unit 210 to transmit a second wireless signal based on the maximum transmission power and controls the system for detecting and locating trapped people 200 to move in an area. In step S520, when a second mobile device registers to the system for detecting and locating trapped people 200 in response to the second wireless signal, the processing unit 230 may record the first location where the system for detecting and locating trapped people 200 currently is to the storage unit 220 and control the system for detecting and locating trapped people 200 to stop at the first location.

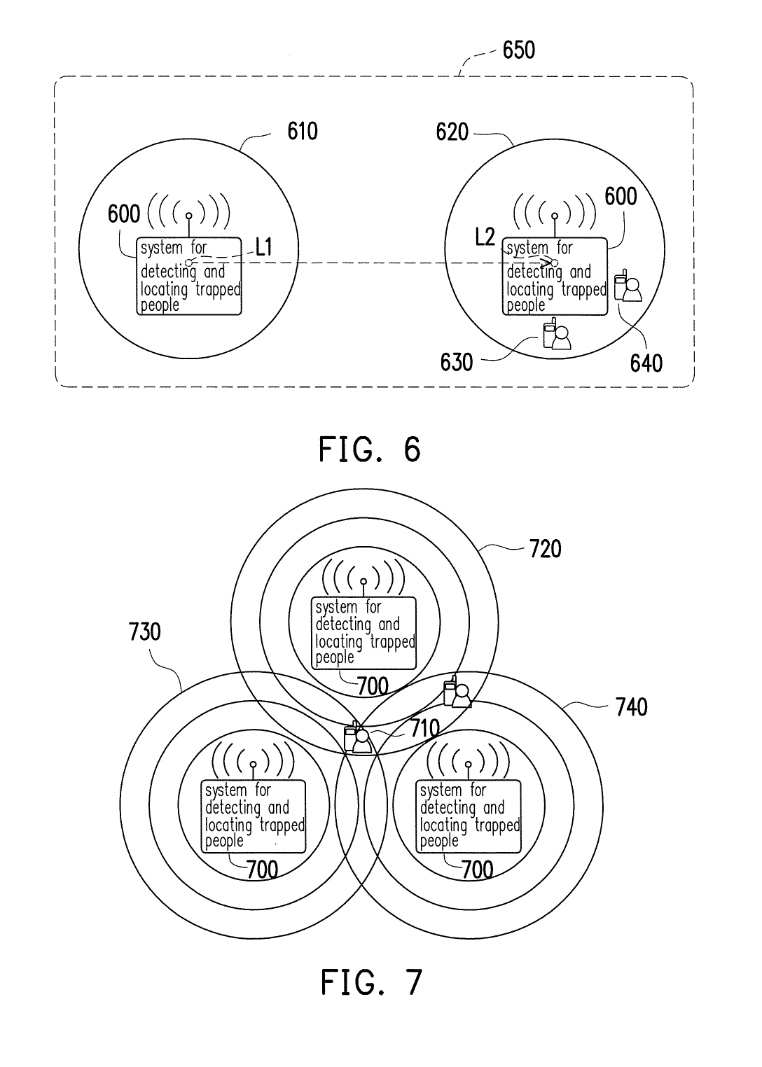

FIG. 6 illustrates a schematic diagram of searching for a mobile device with the maximum transmission power according to the embodiment of FIG. 5. In this embodiment, it is assumed that a system for detecting and locating trapped people 600 being at a location L1 has a transmission range 610 corresponding to the maximum transmission power. Since there is no mobile device within transmission range 610 registered to the system for detecting and locating trapped people 600, the system for detecting and locating trapped people 600 may freely move within an area 650. The area 650 is, for example, a disaster area or other areas designated by designer, which is not limited thereto.

When the system for detecting and locating trapped people 600 moves to a location L2 with transmission range 620, since mobile devices 630 and 640 may register to the system for detecting and locating trapped people 600, the processing unit of the system for detecting and locating trapped people 600 may record the location L2 where the system for detecting and locating trapped people 600 currently is to storage unit of the system for detecting and locating trapped people 600, and control the system for detecting and locating trapped people 600 to stop at the location L2.

Referring back to FIG. 5, in step S530 of FIG. 5, the processing unit 230 may control the communications unit 210 to transmit a first wireless signal based on a transmission power, and record the transmission power to the storage unit 220. Further, as shown in step S320, when a first mobile device responds to the first wireless signal and registers to the system for detecting and locating trapped people 200, the processing unit 230 may record the identity information of the first mobile device to the storage unit 220. The details of steps S530-S540 could be referred to the description of steps S310 and S320 of FIG. 3, which would not be repeated herein.

In step S550, the processing unit 230 may determine whether the transmission power has lasted one unit of time. If no, return to step S540; if yes, proceed to step S560. The unit of time could be any time interval set by the designer, such as 10 minutes, half an hour, etc. As a result, the mobile device would not be too late to register to the system for detecting and locating trapped people 200, and hence the situation that the mobile device corresponds to inaccurate transmission power could be avoided.

In step S560, the processing unit 230 may determine whether the transmission power is the maximum power. If no, the processing unit 230 may proceed to step S570; if yes, the processing unit 230 may proceed to step S580. In step S560, the processing unit 230 may increase transmission power and repeat steps S310-S330. After the transmission power is increased to the maximum power, in step S560, the processing unit 230 may calculate the relative location between the first mobile device and the system for detecting and locating trapped people 200 based on the recorded transmission power and the recorded identify information. The details of steps S560-S580 could be referred to the description of steps S330 and S350 of FIG. 3, which would not be repeated herein.

In step S590, the processing unit 230 may control the system for detecting and locating trapped people 200 to move to a second location, and return to step S530. The second location is, for example, a location in the vicinity of the first location or any other location designated by the designer. In other words, the system for detecting and locating trapped people 200 may gradually increase the transmission power from the initial transmission power to the maximum transmission power again at the second location, and record mobile devices corresponding to each transmission power at the same time. Besides, the system for detecting and locating trapped people 200 may calculate the relative locations between each of the mobile device and the second location again.

In one embodiment, when the system for detecting and locating trapped people 200 is registered by a third mobile device in at least three locations, the processing unit 230 may calculate an absolute location of the third mobile device based on a triangulation locating method.

Referring to FIG. 7, FIG. 7 illustrates a triangulation locating mechanism according to one embodiment of the invention. In this embodiment, assuming that a system for detecting and locating trapped people 700 is respectively registered by a mobile device 710 in the three locations shown in FIG. 7, the system for detecting and locating trapped people 700 may calculate the absolute location of the mobile device 710 based on transmission ranges 720-740, which is the intersection of the transmission range 720-740.

In other embodiments, existence of a plurality of system for detecting and locating trapped person increase the efficiency of locating.

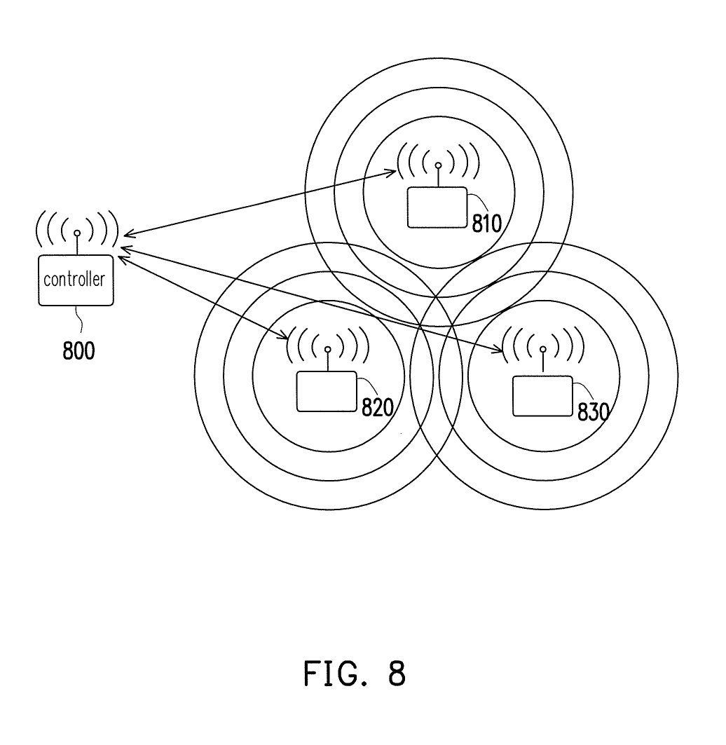

FIG. 8 illustrates a triangulation locating mechanism according to one embodiment of the invention. In this embodiment, systems for detecting and locating trapped people 810-830 may be simultaneously controlled by a controller 800. The controller 800 may be configured to control the movement and location of the systems for detecting and locating trapped people 810-830 and processes various data received from the systems for detecting and locating trapped people 810-830. For instance, the systems for detecting and locating trapped people 810-830 may transmit, either real-time or by batch, the identity information of mobile devices registered to the systems for detecting and locating trapped people 810-830 and the corresponding transmission power to the controller 800, and the controller 800 may calculate the relative locations between each mobile devices and the systems for detecting and locating trapped people 810-830 or the absolute locations of the mobile devices.

To sum up, the locating method and the systems of this embodiment dynamically adjusts the transmission power, records the mobile devices registering to the system for detecting and locating trapped people in response to each transmission power at the same time, and accordingly calculates the relative locations between the systems and the mobile devices. Therefore, when the base stations to which mobile devices originally registered lost communication capabilities, the system for detecting and locating trapped people may accurately locate the mobile devices. Also, after the mobile devices register to the system for detecting and locating trapped people, the mobile devices may enter hibernation mode, thereby save power. As a result, rescuers have more time to locate the user of the mobile devices, and hence the difficulty of rescuing operations could be greatly decreased. Furthermore, since the method in this invention saves the frequent message exchanges between the mobile device and the system for detecting and locating trapped people, a highly accurate locating could be achieved with low power consumption.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A locating method based on dynamically adjusted transmission power, adapted for a system for detecting and locating trapped people, the locating method comprising:
(a) transmitting a first wireless signal based on a transmission power, and recording the transmission power;
(b) when a first mobile device registers to the system for detecting and locating trapped people in response to the first wireless signal, recording identity information of the first mobile device;
(c) determining whether the transmission power is a maximum transmission power;
(d) if no, increasing the transmission power and repeating steps (a) to (d); and
(e) if yes, calculating a relative location between the first mobile device and the system for detecting and locating trapped people based on the recorded transmission power and the recorded identity information.

2. The method as claimed in claim 1, wherein before the step of transmitting the wireless signal based on the transmission power, further comprising:
transmitting a second wireless signal based on the maximum transmission power, and moving in an area; and
when a second mobile device registers to the system for detecting and locating trapped people in response to the second wireless signal, recording and stopping at a first location where the system for detecting and locating trapped people currently is.

3. The method as claimed in claim 2, wherein before the step of determining whether the transmission power is the maximum transmission power, further comprising:
determining whether the transmission power has lasted one unit of time;
if yes, proceeding to step (c); and
if no, returning to step (a).

4. The method as claimed in claim 3, wherein after the step of calculating the relative location between the first mobile device and the system for detecting and locating trapped people based on the recorded transmission power and the recorded identity information, further comprising:
moving to a second location, and repeating steps (a) to (e).

5. The method as claimed in claim 4, further comprising:
when the system for detecting and locating trapped people is registered by a third device in at least three locations, calculating an absolute location of the third mobile device based on a triangulation locating method.

6. A system for detecting and locating trapped people, comprising:
a storage unit, storing a plurality of modules;
a communications unit; and
a processing unit, coupled the storage unit and the communications unit, accessing the modules and executing the following steps:
(a) controlling the communications unit to transmit a first wireless signal based on a transmission power and recording the transmission power to the storage unit;
(b) when a first mobile device registers to the system for detecting and locating trapped people in response to the first wireless signal, recording identity information of the first mobile device to the storage unit;
(c) determining whether the transmission power is a maximum transmission power;
(d) if no, increasing the transmission power and repeating steps (a) to (d); and
(e) if yes, calculating a relative location between the first mobile device and the system for detecting and locating trapped people based on the recorded transmission power and the recorded identity information.

7. The system for detecting and locating trapped people as claimed in claim 6, wherein the processor unit is further configured to:
control the communications unit to transmit a second wireless signal based on the maximum transmission power and move in an area; and
when a second mobile device registers to the system for detecting and locating trapped people in response to the second wireless signal, record a first location where the system for detecting and locating trapped people currently is to the storage unit and control the system for detecting and locating trapped people to stop at the first location.

8. The system for detecting and locating trapped people as claimed in claim 7, wherein the processing unit is further configured to:
determine whether the transmission power has lasted one unit of time;
if yes, proceed to step (c); and
if no, return to step (a).

9. The system for detecting and locating trapped people as claimed in claim 8, wherein the processing unit is further configured to control the system for detecting and locating trapped people to move to a second location and repeat steps (a) to (e).

10. The system for detecting and locating trapped people as claimed in claim 9, wherein when the system for detecting and locating trapped people is registered by a third mobile device in at least three locations, the processing unit is further configured to calculate an absolute location of the third mobile device based on a triangulation locating method.
